(19) United States
(12) Patent Application Publication
(10) Pub. No.: US 2016/0021617 A1
(43) Pub. Date: Jan. 21, 2016

(54) REMOTE SENSOR DATA SHARING FOR ELECTRONIC DEVICE AND ASSOCIATED METHOD

(71) Applicant: MediaTek Inc., Hsin-Chu (TW)

(72) Inventor: Chih-Hsiang HSIAO, Taipei City (TW)

(21) Appl. No.: 14/332,628

(22) Filed: Jul. 16, 2014

(51) Int. Cl. H04W 52/02; H04W 76/02

(52) U.S. Cl. CPC H04W 52/0277; H04W 76/023; H04W 52/0264; H04W 76/045

(57) ABSTRACT

An electronic device and associated method is provided. The electronic device includes: a first sensor; and a processing unit, coupled to the first sensor, wherein the electronic device enters a remote sensor mode when the electronic device is connected to a remote electronic device having a second sensor for generating sensor data, wherein the processing unit executes an application which utilizes the sensor data from the remote electronic device in the remote sensor mode.

### BACKGROUND OF THE INVENTION

1. Field of the Invention

The invention relates to an electronic device and associated method, and in particular to an electronic device for remote sensor data sharing and associated method .

2. Description of the Related Art

Wearable devices, such as watches or other wrist-worn devices, are by their nature relatively small in size, and may be less than 40 mm in diameter. A wearable electronic device with multiple functions such as data display, email, text messaging, and wireless communication requires interact with the device to input data, scroll through software menus, etc. Due to the very limited battery capacity of the wearable device, it is a big challenge to reduce the power consumption of the wearable device.

### BRIEF SUMMARY OF THE INVENTION

A detailed description is given in the following embodiments with reference to the accompanying drawings.

An electronic device is provided. The electronic device includes: a first sensor, for generating first sensor data of the electronic device; and a processing unit, coupled to the first sensor, wherein the electronic device enters a remote sensor mode when the electronic device is connected to a remote electronic device having a second sensor for generating second sensor data, wherein the processor further executes a first application which utilizes the second sensor data from the remote electronic device in the remote sensor mode.

A method for remote data sharing on an electronic device is further provided, wherein the electronic device includes a processing unit and a first sensor. The method includes the steps of: setting the electronic device to enter a remote sensor mode when the electronic device is connected to a remote electronic device having a second sensor for generating sensor data; and executing, by the processing unit, a first application which utilizes the sensor data from the remote electronic device in the remote sensor mode. The sensor data may be raw data, content or context associated with the second sensor.

### BRIEF DESCRIPTION OF THE DRAWINGS

The invention can be more fully understood by reading the subsequent detailed description and examples with references made to the accompanying drawings:

FIG. 1 is a block diagram of an electronic system in accordance with an embodiment of the invention;

FIG. 2 is a block diagram illustrating a wearable device in accordance with an embodiment of the invention;

FIG. 3 is a block diagram of the second electronic device in accordance with an embodiment of the invention;

FIG. 4 is a diagram illustrating installation of a proprietary application on the first electronic device and the second electronic device in accordance with an embodiment of the invention;

FIG. 5A is a diagram illustrating the common operation mode of the second electronic device during the synchronization in accordance with an embodiment of the invention;

FIG. 5B is a diagram illustrating the remote sensor mode during the synchronization in accordance with an embodiment of the invention;

FIG. 6A is a flow chart illustrating the initialization procedure to enter a remote sensor mode by the second electronic device in accordance with an embodiment of the invention;

FIG. 6B is a flow chart illustrating the initialization procedure to enter a remote sensor mode by the first electronic device in accordance with an embodiment of the invention; and

FIG. 7 is a flow chart of a remote data sharing method in accordance with an embodiment of the invention.

### DETAILED DESCRIPTION OF THE INVENTION

The description is made for the purpose of illustrating the general principles of the invention and should not be taken in a limiting sense. The scope of the invention is best determined by reference to the appended claims.

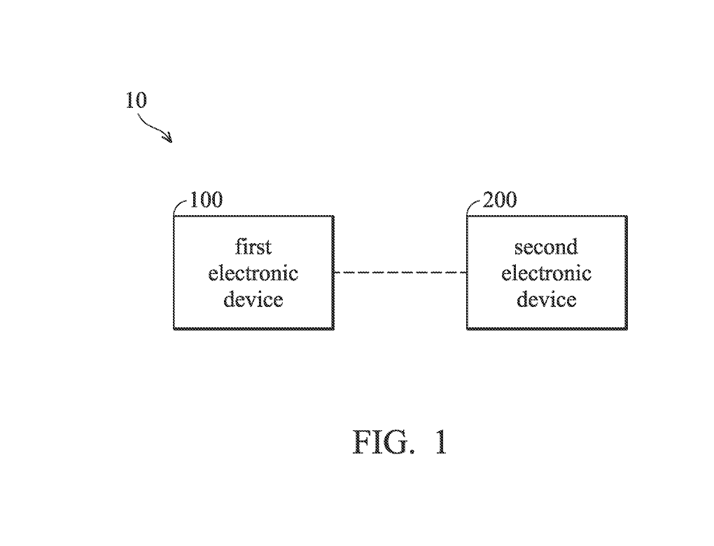

FIG. 1 is a block diagram of an electronic system 10 in accordance with an embodiment of the invention. The electronic system 10 comprises a first electronic device 100 and a second electronic device 200. The first electronic device 100 and the second electronic 200 may connect to each other via a wireless communication protocol, e.g. via Bluetooth low energy (BLE) or near field communication (NFC), and have the same or similar applications installed. For example, the first electronic device 100 and the second electronic device 200 may utilize NFC or BLE to complete the steps of enabling, pairing and establishing a connection when sharing the sensor data. The first electronic device 100 may possess a rich battery capacity such as a smartphone, or a tablet PC, etc. The second electronic device 200 may possess a very limited battery capacity (i.e. compared with the first electronic device 100) such as a smart watch, a smart wristband, smart glasses, or any other type of wearable devices. Alternatively, the first electronic device 100 and the second electronic device 200 may be any type of mobile device, portable device, and/or wearable device, and the battery capacity of the first electronic device 100 is greater than that of the second electronic device 200.

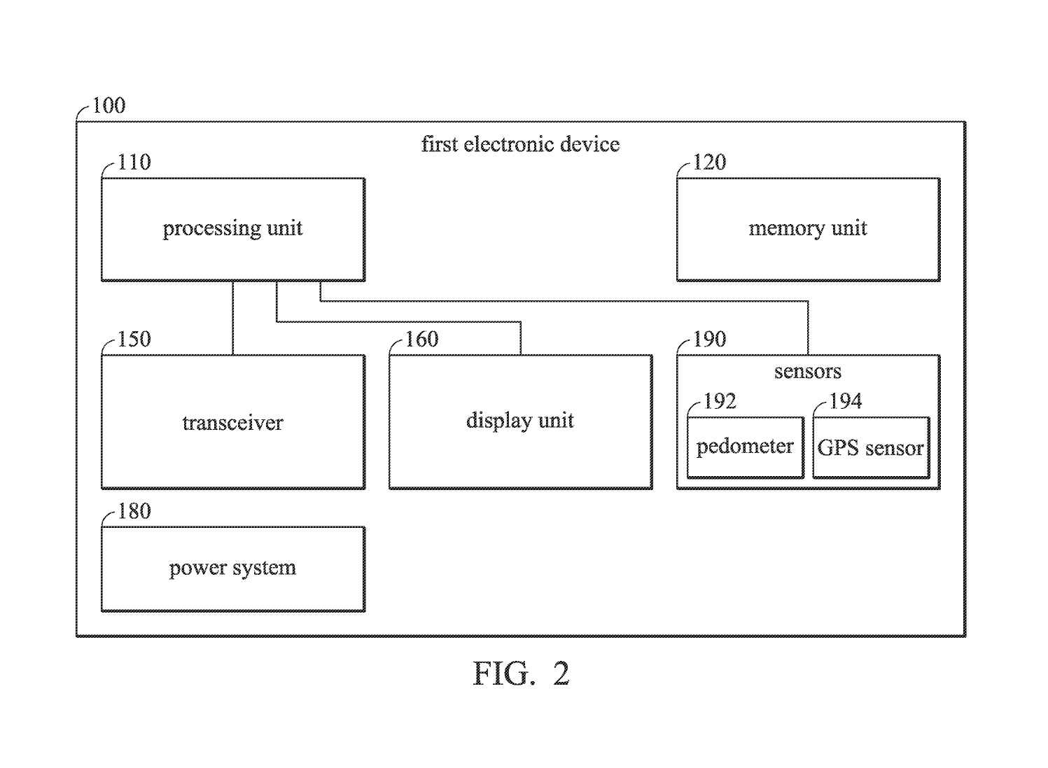

FIG. 2 is a block diagram illustrating the first electronic device 100 in accordance with an embodiment of the invention. The first electronic device 100 comprises a processing unit 110, a memory unit 120, a transceiver 150, a display unit 160, a power system 180 and one or more sensors 190. The processing unit 110 may include one or more processors and/or microcontrollers (MCU). The memory unit 120 may be applied as a main memory for the processing unit 110 for executing software routines and other selective storage functions. For example, the memory unit 120 may comprise a non-volatile memory and a volatile memory (not shown in FIG. 1). The non-volatile memory is capable of holding instructions and data without power and may store the software routines for controlling the first electronic device 100 in the form of computer-readable program instructions. The non-volatile memory (e.g. flash memory, ROM, etc.) may also contain a user interface application, which provides functionality for the first electronic device 100 and can output a graphical user interface on the display unit 160, which may be a touch-sensitive display (i.e. a “touch screen”).

The transceiver 150 is configured to connect the first electronic device 100 to a remote electronic device (e.g. the second electronic device 200) via a wireless communication protocol, and transmitting/receiving packet data during the connection. For example, the BLE or NFC protocols are supported by the transceiver, but the invention is not limited thereto.

The power system 180 is configured to power the various components of the first electronic device 100. The power system 180 may include a power management system, one or more power sources (e.g., battery, alternating current (AC), a recharging system, a power failure detection circuit, a power converter or inverter, a power status indicator (e.g. a light-emitting diode (LED)) and any other components associated with the generation, management, and distribution of power in the first electronic device 100.

The sensors 190, which may include a pedometer 192 and a global positioning system (GPS) sensor 194, couples to the processing unit 110. In an embodiment, the pedometer 192 is configured to count each step a person takes by detecting the motion of the person's hips, and the pedometer 192 may be implemented by using micro-electro mechanical system (MEMS) inertial sensors such as an accelerometer, a gyroscope, and/or a magnetometer (not shown).

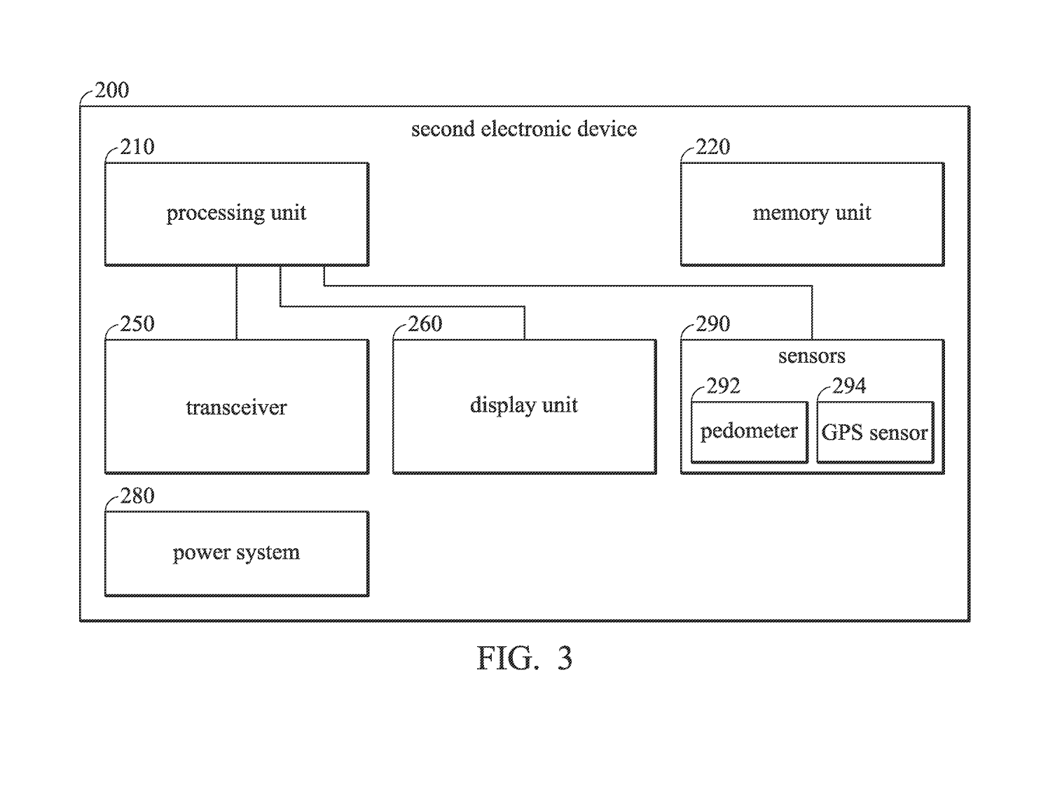

FIG. 3 is a block diagram of the second electronic device 200 in accordance with an embodiment of the invention. As illustrated in FIG. 3, the second electronic device 200 may comprise a processing unit 210, a memory unit 220, a transceiver 250, a display unit 260, a power system 280, a plurality of sensors 290. For example, the second electronic device 200 may be a smart watch or a smart wristband, and the second electronic device 2000 may further include a strap, a wristband, or a bracelet (not shown in FIG. 2). Alternatively, the second electronic device 200 may be a pair of smart glasses, and the second electronic device 200 may further include a spectacle frame and optical lenses (not shown in FIG. 2). Alternatively, the second electronic device 200 may be eyewear with a head-up display (HUD). Thus, the second electronic device 200 may be in any form of wearable accessories, and the invention is not limited to the aforementioned wearable devices. For example, the second electronic device 200 can be wearable on a user's wrist, upper arm, and/or leg, or may be attached to the user's clothing, and may have the functions of a wristwatch, a wearable display, a portable media player, and/or a mobile phone. It should be noted that the second electronic device 200 may be a wearable electronic device, and thus the battery capacity of the second electronic device 200 is very limited when compared with that of the first electronic device 100. Accordingly, the control of power consumption for the second electronic device 200 is very crucial.

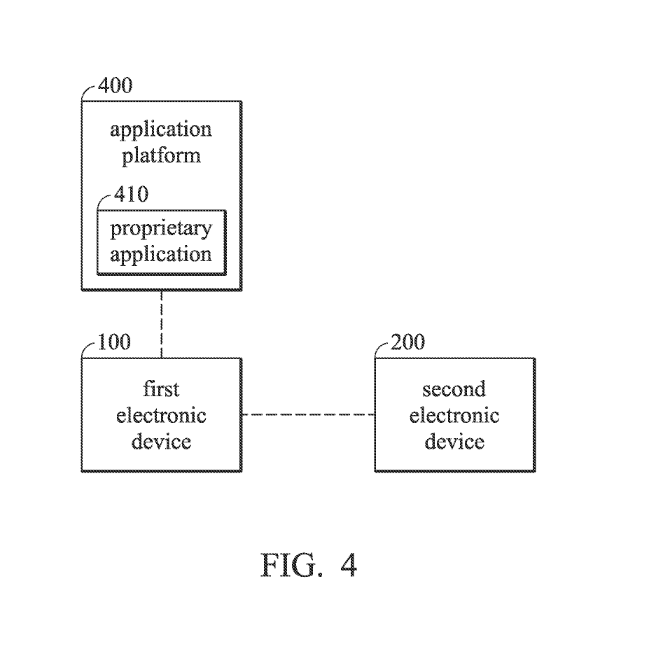

FIG. 4 is a diagram illustrating installation of a proprietary application 410 on the first electronic device 100 and the second electronic device 200 in accordance with an embodiment of the invention. As illustrated in FIG. 4, a proprietary application 410 for monitoring the connection and controlling synchronization between the first electronic device 100 and the second electronic device 200 may be provided by an application source server or an application platform 400 (e.g. Google Play Store). The proprietary application 410 may include two sub-applications in a pair, and one of the sub-applications can be installed on the first electronic device 100, and the other one can be installed on the second electronic device 200. Alternatively, the same proprietary application 410 can be installed on both the first electronic device 100 and the second electronic device 200.

In this embodiment, the proprietary application 410 is downloaded from the application platform 400 by the first electronic device 100, and the proprietary application 410 is installed on the first electronic device 100. Afterwards, a synchronization operation between the first electronic device 100 and the second electronic device 200 is performed through the BLE protocol. Then, the proprietary application 410 or the associated sub-application can be retrieved from the first electronic device 100 by the second electronic device 200. Accordingly, the proprietary application 410 or the associated sub-application can be installed on the second electronic device 200, and the first electronic device 100 and the second electronic device 200 may have the same proprietary application 410 for the remote sensor function. During synchronization, the second electronic device 200 (e.g. a wearable device) may play the role of a master device, and the first electronic device 100 (e.g. a smartphone) may play the role of a slave device (details will be described later).

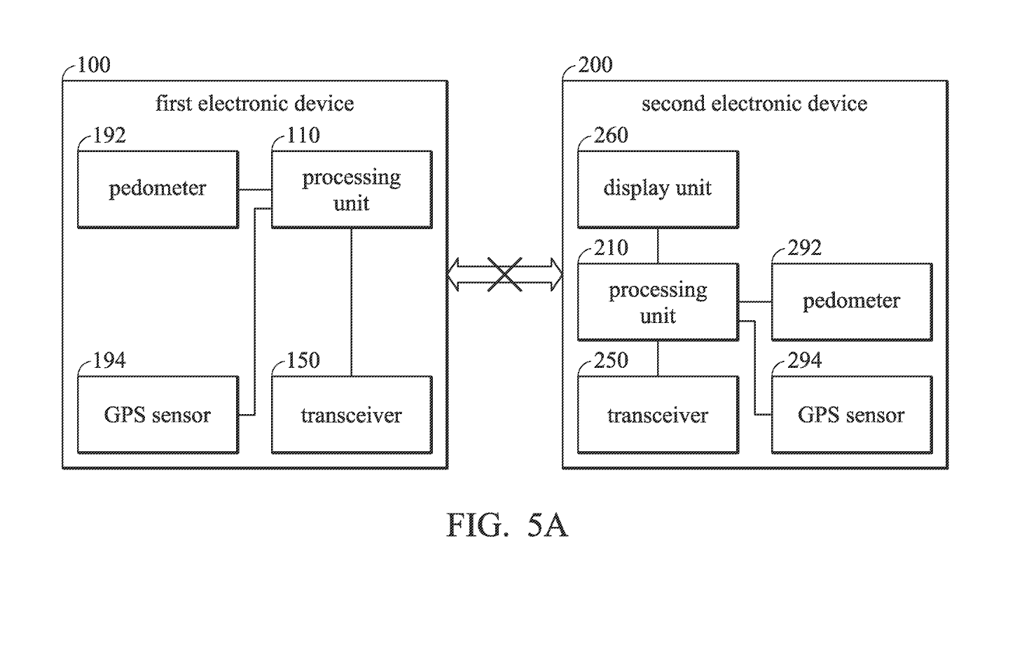

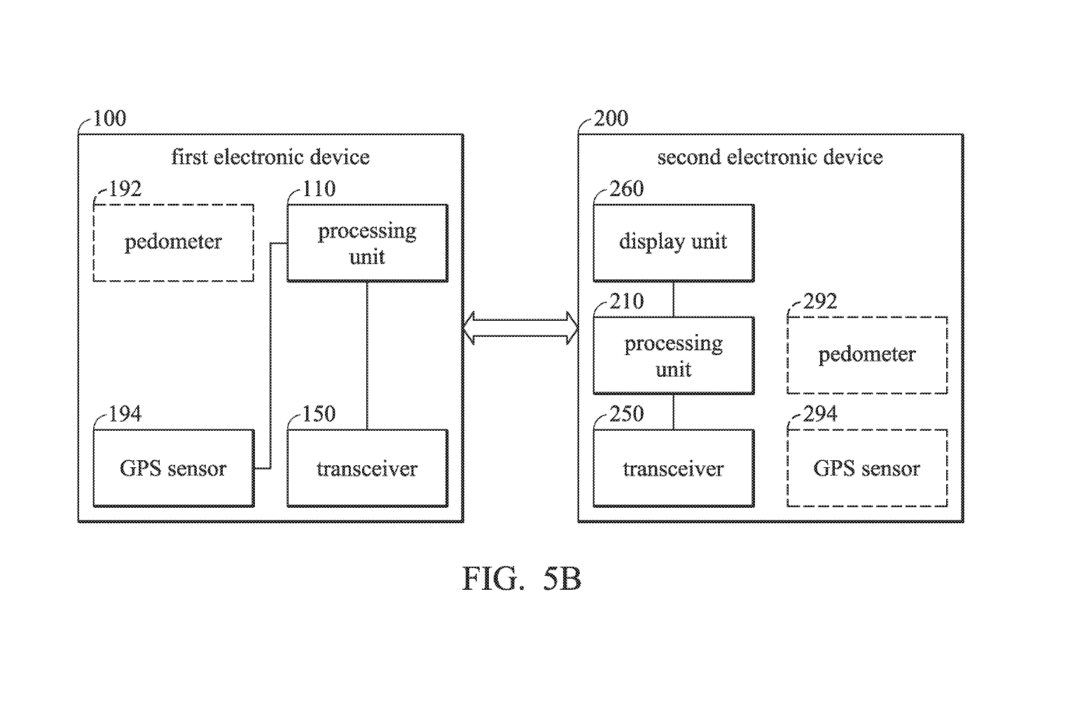

FIG. 5A is a diagram illustrating the common operation mode of the second electronic device 200 during the synchronization in accordance with an embodiment of the invention. FIG. 5B is a diagram illustrating the remote sensor mode during the synchronization in accordance with an embodiment of the invention. Referring to FIG. 5A, the second electronic device 200 may utilize its own pedometer 292 and GPS sensor 294 in some conditions such as (1) the second electronic device 200 is used as a standalone; (2) the connection between the first electronic device 100 and the second electronic device 200 is not established, e.g. the second electronic device 200 does not accept the connection request, or the connection is terminated by the first electronic device 100 or the second electronic device 200; or (3) the signal strength of the connection between the first electronic device 100 and the second electronic device 200 is weak.

Referring to FIG. 5B, when the signal strength of the connection is good enough and the first electronic device 100 accepts the request for sensor data sharing from the second electronic device 200, the connection between the first electronic device 100 and the second electronic device 200 is established. Afterwards, if the application executed by the second electronic device 200 only needs the GPS sensor data, the first electronic device 100 may start to share sensor data associated with the GPS sensor 194 with the second electronic device 200. The second electronic device 200 receives the sensor data from the first electronic device 100 via the transceiver 250 using the BLE connection. Because the same proprietary application (or sub-applications in a pair) is installed on both the first electronic device 100 and the second electronic device 200, the second electronic device 200 may fully utilize the received sensor data from the first electronic device 100 in the proprietary application as using its own sensor data associated with the pedometer 292 and/or GPS sensor 294. In an embodiment, the sensor data from the first electronic device 100 may be raw data sensed by the sensors 190. Alternatively, the sensor data from the first electronic device 100 may be context information, such as time information, geographical information, and/or semantic information, of the first electronic device 100. For example, the first electronic device 100 may execute a context-aware application to determine the context information (e.g. the user's activity, such as “at home”) based on the raw data from the sensors 190. Since the second electronic device 200 is close to the first electronic device 100 while the connection has been established, the second electronic device 200 may directly use the context information from the first electronic device 100. Alternatively, the sensor data from the first electronic device 100 indicates content by processing the raw data sensed by the sensors 190.

In other words, the second electronic device 200 may use the remote sensor data from other electronic device synchronized with the second electronic device 200. Preferably, the transmission of the sensor data from the first electronic device 100 to the second electronic device 200 is via a low-power link, e.g. BLE.

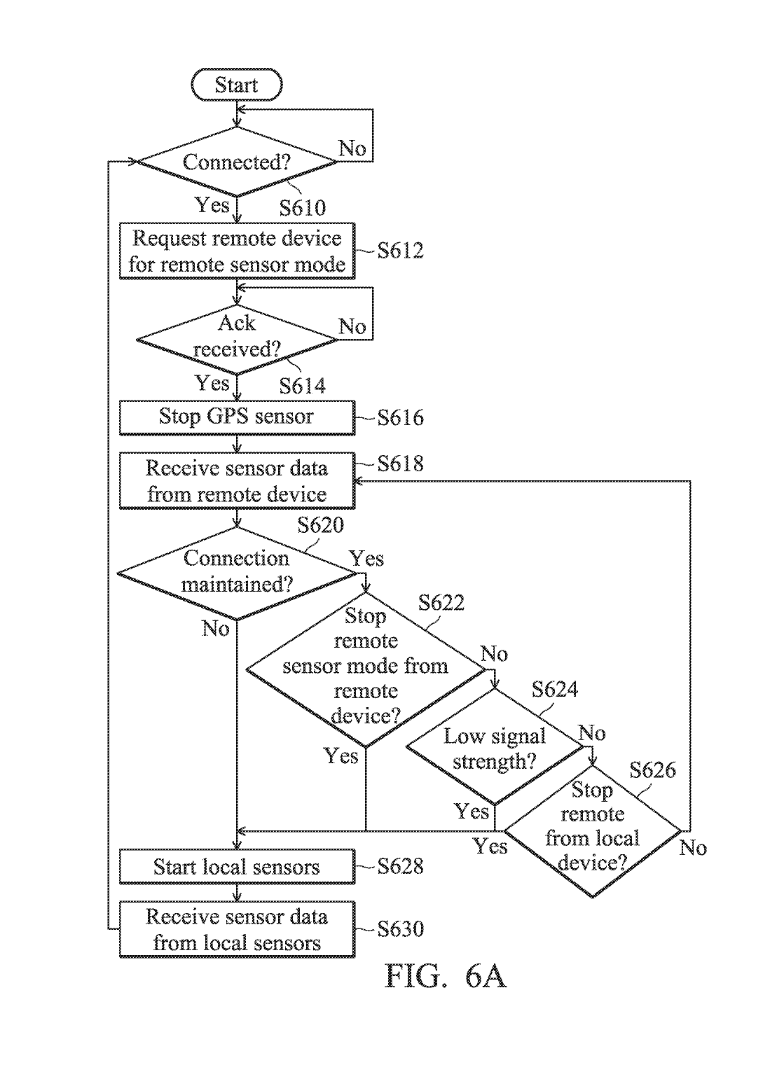

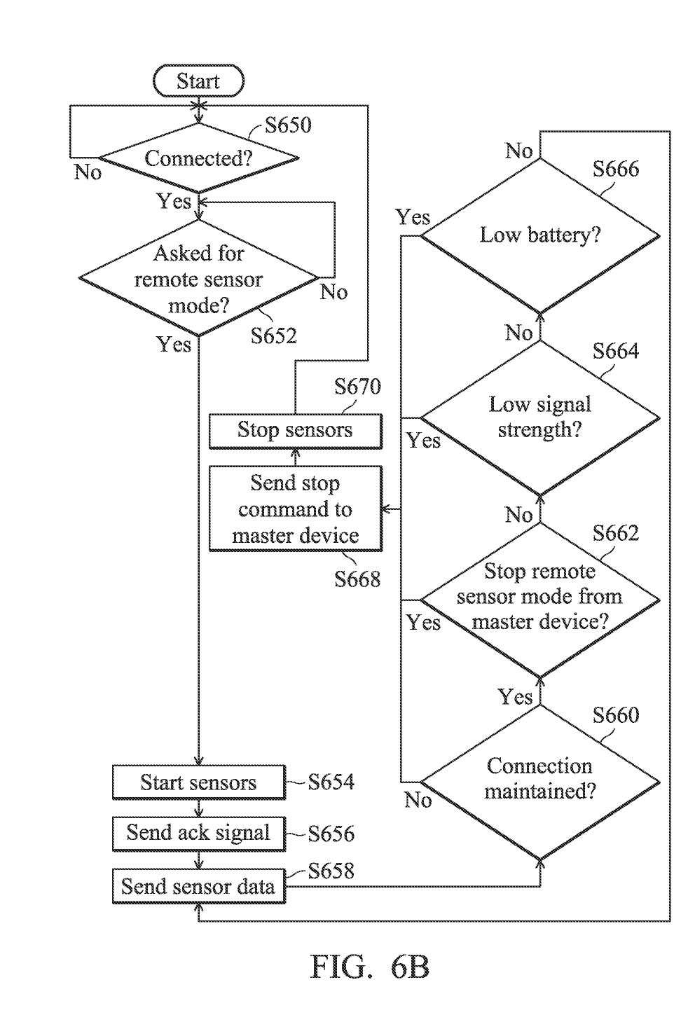

FIG. 6A is a flow chart illustrating an initialization procedure to enter a remote sensor mode by the second electronic device 200 in accordance with an embodiment of the invention. The second electronic device 200 may initialize the synchronization connection as a master device. In step S610, the second electronic device 200 may check whether the connection between the first electronic device 100 and the second electronic device 200 has been established. If so, step S612 is performed. If not, step S610 is performed. In step S612, the second electronic device 200 may send a request signal to the first electronic device 100 to ask to share its sensor data. In step S614, the second electronic device 200 may determine whether an acknowledgment signal from the first electronic device 100 is received. If so, step S616 is performed. If not, step S614 is performed.

In step S616, the second electronic device 200 stops the GPS sensor 294 and/or the pedometer 192 in response to the acknowledgment signal. Then, the second electronic device 200 enters the remote sensor mode as a master device and starts to receive the sensor data from the first electronic device (step S618). Afterwards, the second electronic device 200 further determines when to stop receiving the sensor data from the first electronic device 100. For example, in step S620, the second electronic device 200 determines whether the connection is still maintained. If so, step S622 is performed. If not, step S628 is performed. In step S622, the second electronic device 200 further determines whether a connection termination signal is received from the first electronic device 100. If so, step S628 is performed. If not, step S624 is performed.

In step S624, the second electronic device 200 further determines whether the signal strength of the connection is weak, e.g. the signal strength is lower than a predetermined threshold. If so, step S628 is performed. If not, step S626 is performed. In step S626, the second electronic device 200 further determines whether the connection for remote sensor data sharing is terminated locally on the second electronic device 200, e.g. via a software/hardware button. If so, step S628 is performed. If not, step S618 is performed. In step S628, the second electronic device 200 may exit the remote sensor mode, and activate the previously turned-off pedometer 292 and/or GPS sensor 294, and start to utilize the sensor data from the pedometer 292 and/or GPS sensor 294 (step S630). Afterwards, step S610 is performed, and the processing unit 210 of the second electronic device 200 may determine whether the connection between the first electronic device 100 and the second electronic device 200 has been established. It should be noted that the order of steps S620˜S626 is not limited to the aforementioned embodiment, and the order of steps S620˜S626 can be exchanged.

FIG. 6B is a flow chart illustrating the initialization procedure to enter a remote sensor mode by the first electronic device 100 in accordance with an embodiment of the invention. In step S650, the first electronic device 100 may determine whether the connection between the first electronic device 100 and the second electronic device 200 has been established. If so, step S652 is performed. If not, step S650 is performed. In step S652, the first electronic device 100 may determine whether the first electronic device 100 has been asked for the sensor data by the second electronic device 200. If so, step S654 is performed. If not, step S652 is performed. In step S654, the first electronic device 100 may activate the pedometer 192 and/or the GPS sensor 194, and then send an acknowledgment signal to the second electronic device 200 (step S656), thereby establishing the connection. After the connection between the first electronic device 100 and the second electronic device 200 has been established, the first electronic device 100 may enter the remote sensor mode as a slave device and start to send the sensor data from the pedometer 192 and/or the GPS sensor 194 to the second electronic device 200, e.g. via BLE protocol (step S658).

While sending the sensor data to the second electronic device 200, the first electronic device 100 may further determine whether to stop sending the sensor data occurs. For example, in step S660, the first electronic device 100 may determine whether the connection between the first electronic device 100 and the second electronic device 200 is maintained. If so, step S662 is performed. If not, step S668 is performed. In step S662, the first electronic device 100 may further determine whether a request signal to turn off the remote sensor mode is received from the second electronic device 200 (e.g. associated with step S626 in FIG. 6A). If so, step S668 is performed. If not, step S664 is performed. In step S664, the first electronic device 100 may further determine whether the signal strength of the connection is low, e.g. the signal strength is lower than a predetermined threshold. If so, step S668 is performed. If not, step S666 is performed. In step S666, the first electronic device 100 may further determine whether the remaining battery capacity of the first electronic device 100 is lower than a predefined threshold, e.g. 10% battery capacity. If so, step S668 is performed. If not, step S658 is performed to keep sending sensor data to the second electronic device 200.

In step S668, the first electronic device 100 may send a stop command to the second electronic device 200. In step S670, the first electronic device 100 may exit the remote sensor mode and turn off the pedometer 192 and/or the GPS sensor 194. Afterwards, step 5650 is performed to check whether the connection between the first electronic device 100 and the second electronic device 200 has been established.

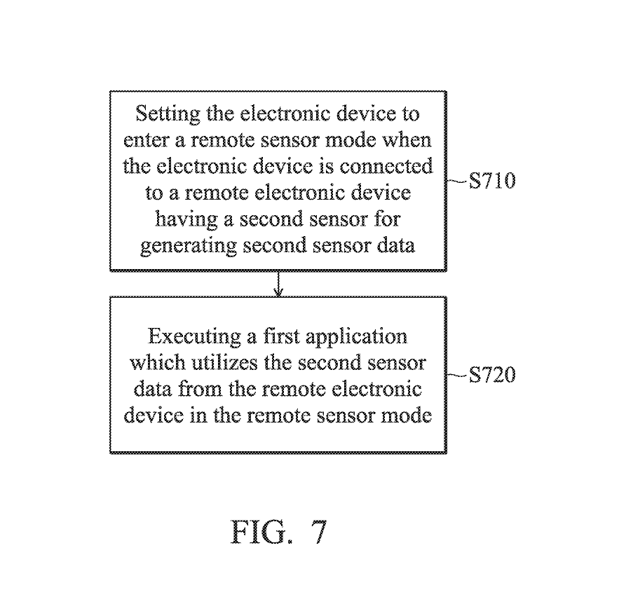

FIG. 7 is a flow chart of a remote data sharing method in accordance with an embodiment of the invention. In step 5710, the second electronic device 200 enters a remote sensor mode when the second electronic device 200 is connected to a remote electronic device (e.g. the first electronic device 100) having at least one second sensor. In step 5720, the second electronic device 200 executes a first application which utilizes second sensor data from the remote electronic device (e.g. from the pedometer 192 and/or the GPS sensor 194 of the first electronic device 100) instead of the first sensor data (e.g. from the pedometer 292 and/or GPS sensor 294) in the remote sensor mode. It should be noted that the second electronic device 200 may turn-off the pedometer 292 and/or GPS sensor 294 when entering the remote sensor mode. Both the first electronic device 100 and the second electronic device 200 may keep monitoring whether to exit the remote sensor mode (e.g. steps S620˜S626 in FIG. 6A, and steps S660˜S666 in FIG. 6B).

In view of the above, a remote sensor data sharing method for an electronic device is provided. In the invention, the second electronic device having a relatively low battery capacity may utilize the sensor data from the first electronic device having a rich battery capacity through a low-power link. Because the sensors are power-consuming in the second electronic device, the burden of power-consuming sensors can be relieved in the second electronic device by using the remote sensor data from the first electronic device.

While the invention has been described by way of example and in terms of the preferred embodiments, it is to be understood that the invention is not limited to the disclosed embodiments. On the contrary, it is intended to cover various modifications and similar arrangements. Therefore, the scope of the appended claims should be accorded the broadest interpretation so as to encompass all such modifications and similar arrangements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a first sensor; and
a processing unit, coupled to the first sensor,
wherein the electronic device enters a remote sensor mode when the electronic device is connected to a remote electronic device having a second sensor for generating sensor data,
wherein the processing unit executes an application which utilizes the sensor data from the remote electronic device in the remote sensor mode.

2. The electronic device as claimed in claim 1, wherein the electronic device and the remote electronic device are connected via a wireless communication protocol.

3. The electronic device as claimed in claim 1, wherein battery capacity of the remote electronic device is greater than that of the electronic device.

4. The electronic device as claimed in claim 1, wherein the sensor data comprises motion and a geographical location of the remote electronic device.

5. The electronic device as claimed in claim 1, wherein the processing unit further turns off the first sensor when entering the remote sensor mode.

6. The electronic device as claimed in claim 1, wherein the first sensor and the second sensor comprise a pedometer and/or a global positioning system (GPS) sensor.

7. The electronic device as claimed in claim 1, wherein the processing unit further sends a request signal to ask the remote electronic device to establish a connection, and the connection is established when the processing unit receives an acknowledgment signal from the remote electronic device.

8. The electronic device as claimed in claim 7, wherein the processing unit further determines whether the connection is maintained,
if so, the processing unit keeps receiving the sensor data from the remote electronic device;
if not, the processing unit exits the remote sensor mode, activates the first sensor, and receives sensor data from the first sensor.

9. The electronic device as claimed in claim 7, wherein the processing unit further determines whether a connection termination signal from the remote electronic device is received,
if so, the processing unit exits the remote sensor mode, activates the first sensor, and receives sensor data from the first sensor;
if not, the processing unit keeps receiving the sensor data from the remote electronic device.

10. The electronic device as claimed in claim 7, wherein the processing unit further determines whether signal strength of the connection is lower than a predetermined threshold,
if so, the processing unit exits the remote sensor mode, activates the first sensor, and receives sensor data from the first sensor;
if not, the processing unit keeps receiving the sensor data from the remote electronic device.

11. The electronic device as claimed in claim 7, wherein the processing unit further determines whether the connection is terminated locally on the electronic device,
if so, the processing unit exits the remote sensor mode, activates the first sensor, and receives sensor data from the first sensor;
if not, the processing unit keeps receiving the sensor data from the remote electronic device.

12. A method for obtaining remote data for an electronic device comprising a
setting the electronic device to enter a remote sensor mode when the electronic device is connected to a remote electronic device having a second sensor for generating sensor data; and
executing, by the processing unit, a first application which utilizes the sensor data from the remote electronic device in the remote sensor mode.

13. The method as claimed in claim 12, wherein the electronic device and the remote electronic device are connected via a wireless communication protocol.

14. The method as claimed in claim 12, wherein battery capacity of the remote electronic device is greater than that of the electronic device.

15. The method as claimed in claim 12, wherein the sensor data comprises motion and a geographical location of the remote electronic device.

16. The method as claimed in claim 12, further comprising:
turning off the first sensor by the processing unit when the electronic device enters the remote sensor mode.

17. The method as claimed in claim 12, wherein the sensor data indicates raw data, content or context associated with the second sensor.

18. The method as claimed in claim 12, wherein the electronic device and the remote electronic device are connected via a BLE protocol.

19. The method as claimed in claim 12, further comprising:
sending a request signal by the processing unit to ask the remote electronic device to establish a connection; and
establishing the connection when the processing unit receives an acknowledgment signal from the remote electronic device.

20. The method as claimed in claim 12, wherein a second application is installed on the remote electronic device so as to provide the sensor data, and the first application and the second application are paired.
